(19) United States
(12) Patent Application Publication
(10) Pub. No.: US 2018/0152523 A1
(43) Pub. Date: May 31, 2018

(54) METHOD FOR REAL-TIME TRANSMISSION OF A DATA STREAM

(71) Applicant: MOTAMA GMBH, Saarbrücken (DE)

(72) Inventors: Marco Lohse, Saarbrücken (DE); Michael Christian Repplinger, Saarbrücken (DE)

(21) Appl. No.: 15/552,266

(22) PCT Filed: Feb. 3, 2015
(86) PCT No.: PCT/DE2015/100046

§ 371 Date: Feb. 5, 2018

(30) Foreign Application Priority Data
Feb. 11, 2014 (DE) 10 2014 101 646.7

(51) Int. Cl. H04L 29/08; H04N 21/254; H04L 29/06; H04N 21/61

(52) U.S. Cl. CPC H04L 67/148; H04N 21/254; H04N 21/6125; H04L 65/4076; H04L 65/4084

(57) ABSTRACT

The invention relates to a method for real-time transmission of a data stream, in particular an audio and/or video data stream, via a network of data processing devices, especially the Internet. In said method, a user interface via which the network is accessible is used for selecting the data stream from among a plurality of data streams made available for transmission. According to the invention, the user interface is used for determining at least one device for receiving the data stream to which the data stream is specifically transmitted and from which the data stream can be transmitted to at least one device in order for the data stream to be utilized, and determining the volume to be transmitted and automatically causing the determined volume of the data stream to be transmitted. The invention further relates to a computer program product and a network of devices for real-time transmission of the data stream.

The invention relates to a method for real-time transmission of a data stream, in particular an audio and/or video data stream, via a network of data-processing devices, in particular the Internet, in which method, by means of a user interface via which the network can be accessed, the data stream can be selected from a plurality of data streams offered for transmission.

The invention also relates to a computer program product and to a network of devices for real-time transmission of the data stream.

Various online services currently provide data streams on their websites, which data streams are referred to as live streams and are intended for transmitting television images for retrieval (“Internet TV”), which images are transmitted by means of peer-to-peer, via streaming servers or via web servers. An individual data stream can be selected from the plurality of offered streams by means of a web interface and can be played, using a streaming client, for example on a smart phone or computer equipped with corresponding software, or on a web-enabled radio or television. Advantageously, a significantly wider audience can be reached using Internet TV in comparison with conventional television transmissions, which are regionally limited. In addition, the audience is no longer tied to regionally broadcast television programming; rather, they can select from an international offering of broadcasts.

A provider of content, e.g. a television station, can thus reach a significantly wider audience. A purchaser of the content, for example an online service provider, can more easily access content to be transmitted, thus allowing said purchaser to broaden its programming relatively easily, thereby attracting new customers. It is, however, problematic that the structure of Internet TV requires significant investment, resources and time for installing a technical infrastructure. In addition, clarifying the legal situation, and agreement on the commercial aspects, between the provider of the content and a purchaser who forwards the content on to the audience, is complex.

The problem addressed by the invention is that of simplifying the establishment of the real-time transmission.

According to the invention, this object is achieved in that at least one device for receiving the data stream, to which device the data stream is transmitted in targeted manner and from which device the data stream can be transmitted to at least one device for using the data stream, as well as a scope of the transmission, is specified by means of the user interface, and the transmission of the data stream in the specified scope is prompted automatically.

A portal for establishing and prompting real-time transmissions of data streams can be created using the method according to the invention. The portal, via which the data stream transmissions can preferably be offered and acquired, is expediently accessed by means of the user interface, which is preferably a graphical interface (GUI) or a speech-based user interface, in order to retrieve information from the data-processing devices interconnected in the network or to transmit said information to the data-processing devices. The portal is designed such that the provider can create and publish the contents of data stream offers and the purchaser can find information on the data stream(s) and purchase one or more of the transmission from the data stream offer. A search function can be provided in order to make it easier to find the data stream offers, by means of which function the purchaser can search for data stream offers by setting search parameters relating to the transmission.

In order to establish the relevant transmission of the data stream, which is made up of a continuous sequence of digital signals (data sets) which constitute a transmitted piece of information, an address of the receiving device in the network is specified via the user interface (an IP address in the case of transmission via the Internet), to which address the data stream is transmitted. Expediently, the transmission is prompted automatically, i.e. the device initiates the transmission in the specified scope by automatic control. The data stream can be transmitted from the receiving device to one or more of the use devices, for example an appliance for playing and/or storing the data stream, by means of which device the audience plays the data stream back in real time and/or optionally stores it to play later. The purchaser can thus broadcast the data stream, optionally following prior processing, from the receiving device via a means available to it for transmitting the data stream, e.g. a cable network, the Internet, by satellite transmission or by terrestrial, preferably analogue or digital transmission, to the use device of its end customer(s).

In one embodiment of the invention, the receiving device is designed to store the data stream, in order to provide said stream for (optionally deferred) retrieval by the use device.

In order to form the portal, information is provided for retrieval on a pilot computer, which information describes a content of the offered data streams, the scope of the offered data streams and the respective rights to be obtained for transmitting the data stream, a price at which the transmission is offered, and/or invoicing and/or payment options for the transmission. Expediently, the provider can input the information via the user interface.

The provider expediently communicates information regarding the original signal, which it provides in the data stream for transmission by means of the method according to the invention, the provider stating technical information, for example relating to a data format, a data rate (bit rate) or a video and/or audio resolution of the original signal.

In addition, the provider provides details on the scope in which the data stream can be retrieved by the receiving device and optionally also by the use device.

The scope and the respective rights to be obtained therefor preferably comprise a software-based field, preferably a data format, an amount of data, a data rate (bit rate) a video and/or audio resolution, a frame rate and/or a number of audio channels.

They may also comprise:
a duration of the transmission,
a geographical region in which the data stream can be transmitted from the receiving device,
a medium via which the data stream can be transmitted from the receiving device, for example the Internet, a cable network, terrestrial transmission or similar,
at least one type of use device which is authorised to play and/or store the data stream, e.g. television, personal or tablet computer, smart phone, set-top box or similar,
an audience that is authorised to play the data stream, for example defined by age,
an authorisation for storage by means of the use device, which authorisation can comprise storage for a limited period of time, and/or
a number of use devices, preferably a maximum number, to which the data stream may be transmitted.

In a particularly preferred embodiment of the invention, at least one scope, preferably various scopes, in which the data stream can be offered for retrieval is/are stated by means of the user interface in order to provide the information relating to the scope. Preferably, a choice is provided by the user interface for the provision of the information relating to the at least one scope in which the data stream can be offered for retrieval, the user interface expediently only providing those scopes which can be produced by means of the method according to the invention.

The various scopes preferably differ from a scope of the original signal, the content of which is transmitted as the data stream, in particular in terms of the data format, the data rate (bit rate), the video and/or audio resolution, the frame rate and/or the number of audio channels.

In one embodiment of the invention, the data stream can be requested for transmission in a specified scope by means of the user interface. Expediently, it is subsequently verified whether the data stream can be provided in the scope and, optionally, additional method steps are prompted.

Preferably, the pilot computer provides options for the scope to be offered for retrieval, from which options the provider can choose, in order to generate the data stream offer via the user interface, preferably based on the information regarding the original signal.

With respect to the software-based field of the scope, the pilot computer specifies in which scope the data stream can be produced for transmission from the original signal, which is explained in more detail in the following, and provides the options for retrieval, optionally in a corresponding list of the various possible scopes, it being possible for the options to comprise for example ranges of the data rate (bit rate), the video and/or audio resolution, the frame rate and/or the number of audio channels. The provider selects the scope(s) to be offered from the various possible scopes.

The information characterising the content is expediently made up of key words, information text, an audio sample and/or a preview, which can be played by means of the user interface.

The price can be set individually for each transmission to one of the receiving devices, or it may also depend on the scope of the transmission, for example the data rate or the duration.

It is also conceivable for the price to depend on the transmission from the receiving device to the use device(s), in particular on the number of use devices to which transmissions are made, on the type of use device, on the geographical arrangement of such devices, or similar.

Part of the price is preferably set by an operator of the network according the invention. This price is determined in one embodiment of the invention on the basis of the transmission, for example based on the amount of data, on a physical distance between the sending device and the receiving device or the use device, and/or on a change in the data stream during transmission (explained in more detail in the following), in particular the processing power required therefor.

The options for paying for the transmission can comprise direct payment via the user interface, for example by a credit card payment or a direct debit being authorised via the user interface in a manner known per se. The part of the price relating to the transmission is paid to the operator. The provider receives the part of the price relating to providing the data stream.

Various options can be provided for invoicing which take account of different requirements, for example different states. In particular, one invoice can be generated for the provider and one for the operator of the network according to the invention.

In a further embodiment of the invention, the information provided for retrieval is processed such that it can be searched by means of the user interface by specifying search criteria which preferably relate to the scope and/or contents of the offered data streams, rights which can be obtained for transmitting the data streams, prices at which the transmission is offered, and/or invoicing and/or payment options for the transmission. For the purpose of simple navigation, a search form is expediently created by means of the user interface, on the basis of which form the search criteria can be selected and specified.

In the preferred embodiment of the invention, the user interface is designed such that, by selecting at least one of the offered data streams in one of the offered scopes, a contract regarding the transmission of the data stream can be concluded between the named provider and the named purchaser of the data stream.

When a contract is successfully concluded, an invoice is automatically generated for the transmission of the data stream either before the transmission or thereafter depending on the agreement, and this invoice is sent to the provider and to the purchaser. In addition, payment can be prompted automatically.

Following conclusion of the contract, in the preferred embodiment of the invention, transmission information, which is input via the user interface and comprises at least the scope of the transmission and the address of the receiving device, is automatically transmitted from the pilot computer mentioned to a device for automating the transmission, and the automation device prompts the transmission in the agreed scope based on the transmission information by controlling the transmission to the receiving device, optionally as far as to the use device.

In the simplest case, the data stream is transmitted directly from a sending device, which is designed to feed the data stream into the network of data-processing devices mentioned at the outset, to the receiving device. The automation device prompts the provision of the data stream in the agreed scope and the transmission to the receiving device.

In one embodiment of the invention, the data stream is transmitted from the sending device to at least one device for modifying the data stream, which modification device is designed to alter the data stream, and preferably transmits the data stream to a plurality of receiving devices, the automation device expediently specifying an address of the modification device in the network (an IP address in the case of transmission via the Internet). In order to alter the data stream, the modification device expediently comprises a modification computer for altering the data stream.

In order to be able to offer the data stream in various scopes, or different data formats or data rates, the modification device expediently transcodes the data stream; the data format, the data rate (bit rate), the video and/or audio resolution, the frame rate and/or the number of audio channels preferably being altered.

Preferably, the modification device is designed to simultaneously provide the data stream for transmission in a plurality of scopes in order be able to transmit the data stream in various scopes to various receiving devices.

In a further embodiment of the invention, the modification device alters the contents of the data stream. If the contents can be removed or replaced, at least in portions, the data stream, in particular the advertising contained therein, can be adjusted to the receiver served by the relevant receiving device.

It goes without saying that the modification device can also forward the data stream unaltered if the data stream is to be transmitted to the or one of the receiving devices in the scope in which the data stream is already transmitted to said modification device.

In addition, in principle the receiving device could also be provided such that it can alter the data stream as explained above. The purchaser, i.e. the operator of the receiving device, can then make the data stream available to the audience in the various scopes.

In particular in order to be able to achieve the large processing powers which are required for simultaneously altering a plurality of the data streams, the modification device itself expediently comprises a network of a plurality of interconnected modification computers (cloud computing), which network preferably dynamically adapts to processing power requirements in order to alter the data stream.

In order to transmit the data stream, the automation device controls the modification device such that the data stream is altered such that it can be transmitted to the receiving device in the agreed scope. It goes without saying that the modification device alters the data stream only in the scope required in each case.

In a further embodiment of the invention, the data stream is transmitted from the sending device to at least one device for forwarding the data stream, which forwarding device forwards the data stream unaltered, as it has been received, and from there said stream is transmitted to the receiving device. The automation device expediently specifies an address of the forwarding device in the network for this purpose (an IP address in the case of transmission via the Internet). In particular if a plurality of such forwarding devices are provided, and a targeted transmission from forwarding device to forwarding device becomes possible, said devices are used, as explained in more detail in the following, to influence a transmission route via which the data stream reaches the receiving device from the sending device.

It goes without saying that, depending on the requirements of the transmission, the modification device and the forwarding device can be provided between the sending device and the receiving device in any desired number and sequence.

In a preferred embodiment of the invention, the sending, forwarding and modification devices, and the receiving device, are designed to transmit the data stream by means of UDP/IP (User Datagram Protocol/Internet Protocol), preferably by means of UDP unicast or UDP multicast and/or by means of TCP/IP (Transmission Control Protocol/Internet Protocol) and/or by means of protocols based thereon, in particular in MPEG-TS format (MPEG transport stream).

Expediently, the data stream can also be transmitted between the sending, forwarding and modification devices, and the receiving device, and optionally also to the use device, in an encrypted form in order to prevent unauthorised access by third parties, in particular when sending between the above-mentioned devices via the Internet. It goes without saying that the above-mentioned devices can be accordingly designed to encrypt and decrypt the data stream.

In one embodiment of the invention, the aforementioned automation device controls a transmission route which takes the relevant data stream from the sending device via the forwarding devices and/or the modification devices to the receiving device, preferably taking into account existing resources of the sending, forwarding, modification and/or receiving devices made available for transmission.

In particular if a plurality of data streams are transmitted through the network from different sending devices via optionally a plurality of the forwarding devices or a plurality of the modification devices, there may be different utilisations of the respective devices, and therefore an optimum utilisation of the resources can ensure improvements in the quality of the transmissions.

In addition, transmissions in the same regions can be sent from the sending device at least as far as a first junction, from which the data stream is transmitted to different modification devices, forwarding devices and/or receiving devices, via a common transmission route in order make efficient use of existing resources. The data stream is preferably sent along the transmission route only once. Expediently, the automation device is designed to transmit the data stream as far as possible along a common transmission route.

In addition, the automation device can transmit the data stream via the transmission route having the greatest transmission speed. Advantageously, the transmission speed, which is expediently determined based on the round-trip time, between the sending device and the receiving device can be minimised in order to prevent errors during transmission and to allow a transmission which is as rapid as possible.

In a further embodiment of the invention, the automation device comprises a means for monitoring the transmission, which in each case monitors a capacity of the sending, forwarding, modification and/or receiving devices and/or the quality of the transmission of the relevant data stream.

If the monitoring device detects for example a breakdown or high utilisation of one of the above-mentioned devices, a corresponding piece of information is communicated to the automation device, which changes the transmission route so as to avoid transmission through the device in question.

In order to monitor the quality of the transmission, the monitoring device is expediently designed to compare the data stream on sending from and receipt by the relevant device. For this purpose, in each instance of sending and receipt from device to device, said monitoring device receives monitoring information regarding the data stream from the sending device as well as from the receiving device, and optionally from the modification device or forwarding device additionally used during the transmission. The monitoring can offer control as to whether the data stream is transmitted to the receiving device as contractually agreed.

In addition, monitoring can be used to determine the price of the transmission, for example if the price is calculated according to the duration of the transmission to the receiving device. In this case, the monitoring device communicates the monitoring information to the pilot computer, which automatically generates an invoice based on this and optionally prompts payment.

In addition, monitoring has proven to be particularly advantageous when monitoring information relating to the quality of the transmission is communicated from the monitoring device to the automation device, and the automation device is designed to control the transmission on the basis of the monitoring information.

In a particularly preferred embodiment of the invention, the monitoring device transmits information to the automation device regarding an error during the transmission, and the automation device is designed to modify the transmission based on this error information, in order to correct the error. A particularly high-quality transmission is achieved by means of this method step, which can in principle be carried out for each of the transmissions between the devices transmitting the data stream.

Alternatively or in addition thereto, in order to achieve a high-quality transmission, the forwarding, modification and/or receiving devices can transmit information regarding an error during transmission directly to the devices which, when viewed in the transmission direction, are arranged in front of said devices and send the data stream before said devices, and from which said devices receive the data stream, and the respective sending devices, i.e. the sending, forwarding and/or modification devices are designed to modify the transmission on the basis of the information received regarding the error, in order to correct this error.

The sending device, the modification device, the forwarding device and the receiving device are preferably appliances provided specifically for this purpose, which have the hardware and software required for transmitting and optionally processing the data stream. Alternatively, said devices can also be a computer which is designed to fulfil the functions required for the transmission by means of suitable software.

The sending device expediently has a sending unit by means of which the data stream can be transmitted, and optionally also a receiving unit by means of which the original signal can be received. Said device also preferably comprises a processor for encrypting the data stream to be transmitted, and optionally a processor for decrypting the original signal.

The forwarding device and the modification device expediently comprise a sending unit by means of which the data stream can be transmitted, and a receiving unit by means of which the original signal can be received.

Said devices preferably also each comprise a processor for decrypting the data stream received in each case, and a processor for encrypting the data stream to be transmitted.

The receiving device expediently has a receiving unit by means of which the data stream can be received, and optionally also a sending unit by means of which the data stream can be transmitted. Said device preferably also comprises a processor for decrypting the data stream received in each case, and a processor for encrypting the data stream to be transmitted.

The above-mentioned encryption processor and decryption processor are preferably formed by encryption or decryption computers, or by a chip set up for decryption or encryption.

The computer program product mentioned at the outset, which can be loaded directly onto the internal memory of a digital computer, comprises software portions by means of which at least some of the method steps of the above-described method are carried out when the computer program product is running on a computer.

The network of data-processing devices mentioned at the outset expediently comprises the pilot computer, the automation device and/or the sending device and preferably, in each case individually or in any desired combination, additionally the receiving device, the modification device, the forwarding device and/or the use device.

The invention is explained in more detail in the following on the basis of embodiments and the accompanying drawings relating to the embodiments, in which drawings:

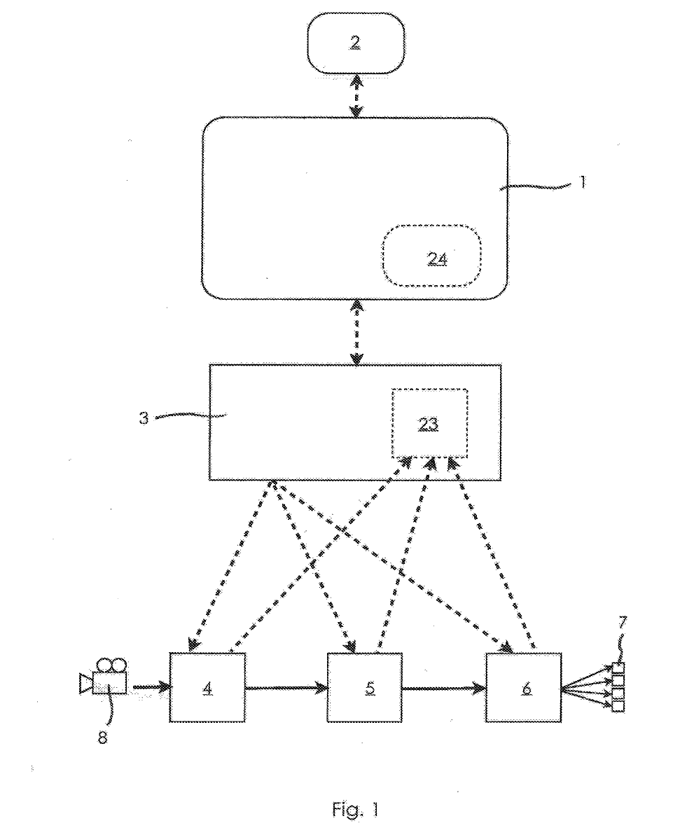

FIG. 1 is a schematic view of a network of data-processing devices according to the invention, and

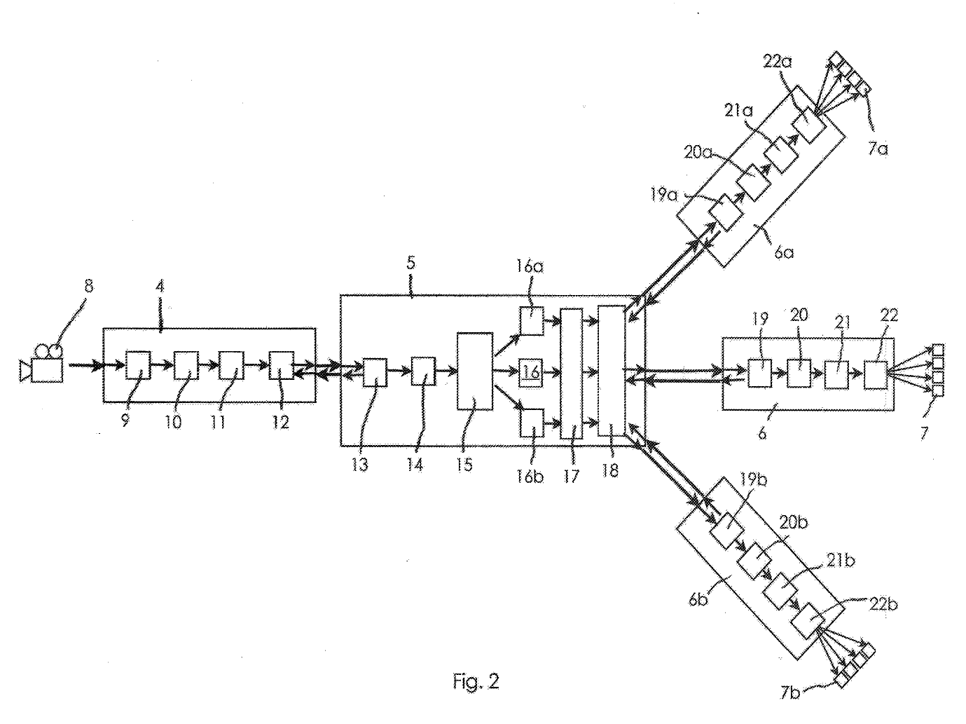

FIGS. 2 to 4 is a schematic view of parts of the network according to the invention from FIG. 1.

A network of data-processing devices according to the invention, as shown in FIG. 1, which is formed in the Internet, comprises a pilot computer 1 by means of which a portal is created for transmitting data streams, which portal can be accessed via the Internet via a user interface 2, e.g. a web interface. The pilot computer 1 is designed to exchange data with an automation device 3 formed by a computer, and transmits information relating to the transmission of the data streams to the automation device 3. The pilot computer 1 further comprises an invoicing and payment means 24, which determines the prices of transmissions, generates invoices and prompts payments accordingly.

The automation device 3 is designed to control, via the Internet, activities of a device 4 for sending a data stream, of a device 5 for modifying the data stream and of a device 6 for receiving the data stream which transmits the data stream to a plurality of devices 7 for using the data stream.

The automation device 3 mentioned further comprises a monitoring means 23 which monitors activities of the sending device 4, of the modification device 5 and of the receiving device 6, and optionally also of the use devices 7.

The sending device 4 is an appliance which is equipped with hardware and software and which receives a standard real-time data stream, e.g. a data stream in MPEG transport stream format, via a User Datagram Protocol (UDP) of a unicast or multicast transmission, by means of a receiving device 9 shown in FIG. 2, and transmits said stream via the Internet by means of a sending unit 12 to the modification device 5. The sending device 4, which receives the standard real-time signal, e.g. from a television station 8, in an encrypted manner, decrypts the received data stream by means of a processor 10, changes the protocol in which the data stream is transmitted, before transmission to the modification device 5, and/or encrypts the data stream by means of a processor 11 in order to prevent unauthorised access by third parties.

The modification device 5 comprises a receiving appliance 13 which is provided with corresponding hardware and software and which can receive the data stream from the sending device 4 via the Internet, a processor 14 for decrypting the standard real-time signal, and also a modification computer 15 which is designed to alter contents of the data stream by replacement and/or to transcode the data stream, for example in order to change the data format, the data rate (bit rate), the video and/or audio resolution and/or the frame rate of said stream, and optionally to generate a plurality of different transcoded data streams 16a, 16b. The modification computer 15 also forwards the received data stream unaltered (data stream 16 in FIG. 2) if the data stream received thereby is required in the scope in which it was transmitted thereto. The modification device 5 further comprises a processor 17 for encrypting the data streams 16, 16a, 16b, and a sending appliance 18 which is likewise provided with corresponding hardware and software and transmits the encrypted data stream(s) via the Internet to the receiving device 6, optionally to a plurality of the receiving devices 6, 6a, 6b.

The receiving devices 6, 6a, 6b each have a receiving appliance 19, 19a, 19b which is equipped with corresponding hardware and software and is suitable for receiving the data stream from the modification device 5. The receiving devices 6, 6a, 6b also have processors 20, 20a, 20b for decrypting the data streams transmitted in each case by the modification device 5. By means of a processor 21, 21a, 21b, the receiving devices 6, 6a, 6b are designed to encrypt the respective data streams for transmission to the use devices 7, 7a, 7b. The receiving devices 6, 6a, 6b each further comprise a sending appliance 22, 22a, 22b which is equipped with corresponding hardware and software and by means of which the data stream can be transmitted to the use devices 7, 7a, 7b, it being possible for this transmission to take place for example via the Internet, via a cable network, terrestrial transmission, satellite transmission or similar.

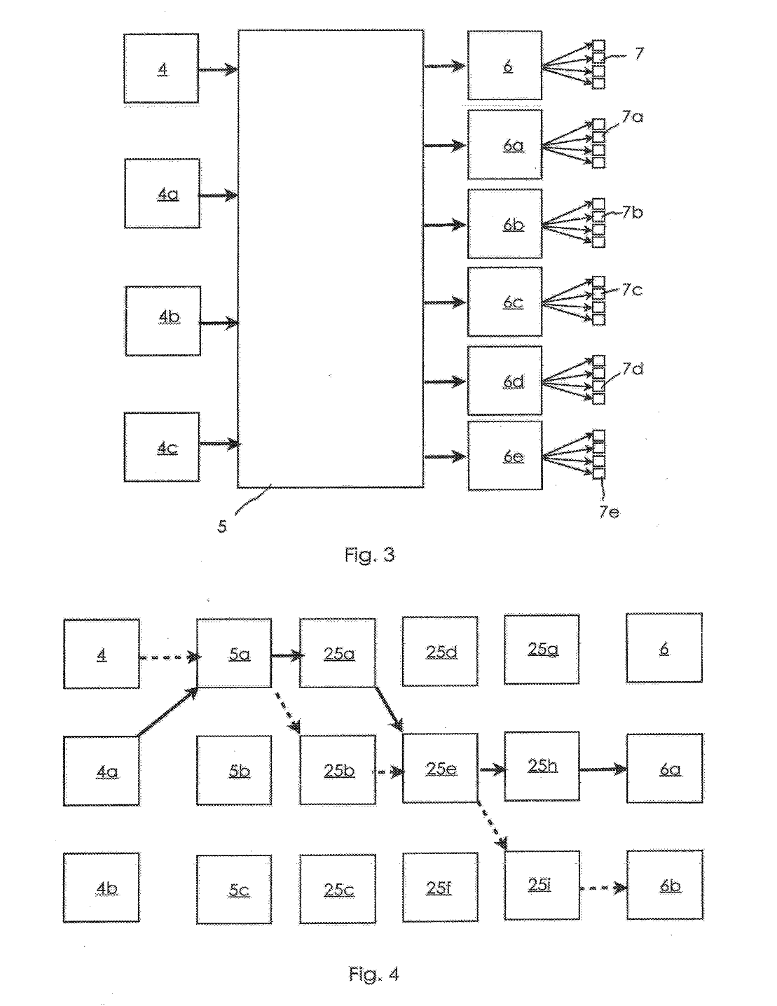

As shown in FIG. 3, the modification device 5 can be designed to simultaneously receive and process a plurality of data streams from various sending devices 4-4c, and to send said streams to a plurality of receiving devices 6-6e. For this purpose, the modification device 5 can be formed by a network of a plurality of interconnected modification computers (cloud computing), which network dynamically adjusts to a processing power requirement in order to alter the data stream.

It goes without saying that a plurality of the modification devices 5 can also be provided, which devices can optionally be used to alter the data streams from the various sending devices 4-4c, which in turn transmit to various receiving devices 6-6e (cf. FIG. 4).

The user interface 2 is designed such that a provider of a data stream, for example a television station, wishing to broadcast one of its channels via the Internet, or a company which transmits live sports events, can provide a transmission offer for retrieval.

When the provider creates an offer, it provides information which characterises the offered data stream, such as a title, a description, key words or a preview.

In addition, it states the scope in which the data stream is intended to be provided for transmission to the receiving device and/or to the use device, for example by stating a duration of the transmission as well as a transmission region in which the data stream can be transmitted from the receiving device.

With respect to the details relating to a data format, a data rate, a video and/or audio resolution and/or a number of audio channels, the user interface gives the provider a choice of various data formats, data rates, video and/or audio resolutions and/or numbers of audio channels, which can be provided for transmission by means of the network according to the invention by altering the data stream by means of the modification device. The modification device is designed to convert the data stream into all common data formats, data rates and video and/or audio resolutions such that the provider can offer the data stream in a plurality of scopes and therefore has a large number of options; the data stream can also potentially be offered to the purchaser in many different scopes. Preferably, the user interface is designed such that the provider and/or the purchaser can select particular ranges from specified ranges of the data rates and the video and/or audio resolutions.

Further details could be a transmission medium, for example a cable network or the Internet, via which the data stream can be transmitted to the use device, or types of use devices, for example televisions, smartphones, personal or desktop computers, which are authorised to use the data stream.

In addition, information regarding rights which can be obtained for transmitting the data stream is made available via the user interface 2. The prices at which the transmission is offered result from the price set by the provider, and from the price set by an operator of the platform for the transmission.

The price set by the provider may for example depend on the number or the spatial arrangement of the use devices to which the data stream is transmitted, and on the data format of the data stream.

The operator's price can be determined automatically by the invoicing and payment means 24, taking into account the scope of the transmission, in particular the amount of data to be transmitted, the change to be made to the original signal or the data stream and/or the physical distance between the sending device and the receiving device.

Further details can include invoicing and payment options for the transmission.

The data which are input for generating the offer are processed by means of the pilot computer 1 so as to be retrievable on the Internet via the user interface 2, so that a purchaser of the data stream, for example a telecommunications provider intending to transmit the data stream to its end clients, can be informed. For this purpose, a search function is expediently provided which allows the purchaser to filter offers which are suitable for it from the offers which can be retrieved by means of the user interface 2, by pre-selecting the above-mentioned information relating to the data stream.

If the purchaser wishes to purchase a data stream offer, it selects said offer by providing the information mentioned relating to the scope, rights, invoicing and payment, as well as an IP address at which the receiving device 6 is located, and, via the user interface 2, concludes a contract with the provider regarding the transmission of the data stream.

The stated invoicing and payment means 24 of the pilot computer 1 automatically generates corresponding invoices and forwards these to the provider, the purchaser and the operator of the network, and prompts payment of the price, for example by charging a credit card of the purchaser to the benefit of the operator, and the operator paying the part of the payment to which the provider is entitled.

The pilot computer 1 communicates to the automation device 3 transmission information relating to the transmission of the data stream to the receiving device 6, the automation device automatically prompting the transmission in the agreed scope from the sending device 4, to which the provider sends its standard real-time data stream, via the modification device 5 such that the purchaser receives the data stream in the agreed scope on the receiving device 6, the modification device 5 in particular altering the data format, the data rate and the audio and/or video resolution of the data stream.

During transmission, the sending device 4, the modification device 5 and the receiving device 6 are monitored. It is thus possible to verify whether the data stream has been transmitted to the receiving device 6 in the contractually agreed scope. It can be provided for the automation device 3 to communicate monitoring information, which has been determined by the monitoring means 23, to the pilot computer 1, such that, when the transmission is as agreed, said computer automatically generates an invoice and prompts payment, as described above.

In addition, if an error is detected during transmission, the automation device 3 can alter the activities of the sending device 4 and the modification device 5a, 5b, 5c such that the error is prevented.

As shown in FIG. 2 by the double arrows between the sending device 4, the modification device 5 and the receiving device 6, the receiving appliances 13 and 19 can transmit information regarding errors occurring during transmission to the relevant sending unit 12 or sending appliance 18 from which said appliances receive the data stream in each case. The sending unit 12 and the sending appliance 18 are designed to modify the transmission on the basis of the information they receive regarding the errors, such that the errors are prevented or corrected.

As can be seen in FIG. 4, in addition, forwarding devices 25a-i and, alternatively, a plurality of the modification devices 5a, 5b, 5c, can be provided on a transmission route from the sending device 4, 4a, 4b to the receiving devices 6, 6a, 6b, via which the data stream is routed. In particular, if a plurality of the sending devices 4, 4a, 4b and the receiving devices 6, 6a, 6b are provided, and a plurality of data streams are to be transmitted, in order to improve a transmission quality it can be useful to direct each of the data streams by selecting the forwarding devices 25a-i via which the data stream is transmitted, it being possible to take into account the speed of a transmission based on round-trip times, or also utilisations of the modification devices 5a, 5b, 5c determined by the monitoring means 23.

1. A method real-time transmission of a data stream, in particular an audio and/or video data stream, via a network of data-processing devices, in particular the Internet, in which method, by means of a user interface via which the network can be accessed, the data stream can be selected from a plurality of data streams offered for transmission,
characterized in that
at least one device for receiving the data stream, to which device the data stream is transmitted in a targeted manner and from which the data stream can be transmitted to at least one device for using the data stream, as well as a scope of the transmission, is specified by means of the user interface, and the transmission of the data stream in the specified scope is prompted automatically.

2. The method according to claim 1,
characterized in that
the data stream can be transmitted from the receiving device via a means for distributing the data stream, preferably the Internet, a cable network, by satellite transmission or by terrestrial transmission, to a plurality of the use devices.

3. The method according to claim 1,
characterized in that,
by means of the interface, information can be provided for retrieval which describes the scope and/or contents of the at least one offered data stream, rights for transmitting the data stream which can be obtained, prices at which the transmission is offered, and/or invoicing and/or payment options for the transmission.

4. The method according to claim 3,
characterized in that
the information provided for retrieval is processed such that it can be searched by means of the user interface by specifying search criteria which preferably relate to the scope and/or contents of the offered data streams, rights for transmitting the at least one data stream which can be obtained, prices at which the transmission is offered, and/or invoicing and/or payment options for the transmission.

5. The method according to claim 1,
characterized in that,
by means of the user interface, by selecting the at least one offered data stream, a contract regarding the transmission of the data stream is concluded between a provider and a purchaser of the data stream.

6. The method according to claim 5,
characterized in that
an invoice is automatically generated and/or paid when a contract is concluded for transmission of the data stream.

7. The method according to claim 1,
characterized in that
the scope comprises a data format, a data rate (bit rate), a video and/or audio resolution, a frame rate, a number of audio channels, a transmission duration, a transmission region in which the data stream can be transmitted from the receiving device, a transmission medium via which the data stream can be transmitted from the receiving device, at least one type of use device authorized for the use, an audience authorized to use the data stream and/or an authorization for storage by means of the use device.

8. The method according to claim 3,
characterized in that
at least one scope, preferably various scopes, in which the data stream can be offered for retrieval are specified by means of the user interface in order to provide the information relating to the scope, the user interface preferably providing a choice of the at least one scope in which the data stream can be offered for retrieval, in order to provide the information via the user interface.

9. The method according to claim 8,
characterized in that
the various scopes differ from a scope of an original signal, the content of which is transmitted as the data stream, in particular with respect to the data format, data rate (bit rate), the video and/or audio resolution, the frame rate and/or the number of audio channels.

10. The method according to claim 1,
characterized in that,
by means of the user interface, the data stream is requested for transmission in a specified scope, and it is preferably subsequently verified whether the data stream can be provided in the scope.

11. The method according to claim 1,
characterized in that
the data stream is transmitted from a device for sending the data stream to at least one device for modifying the data stream and/or to at least one device for forwarding the data stream, optionally to a plurality of the receiving devices.

12. The method according to claim 11,
characterized in that
the data stream is transmitted to the receiving device (6) via a plurality of the modification devices and/or via a plurality of the forwarding devices.

13. The method according to claim 11,
characterized in that
the data stream is encrypted and/or decrypted by means of the sending device, the modification device, the forwarding device and/or the receiving device.

14. The method according to claim 11,
characterized in that
the data stream is preferably altered by means of the modification device (5) and/or the receiving device, preferably by the data stream being transcoded and/or the contents of the data stream being altered, in particular removed and/or replaced, at least in portions.

15. The method according to claim 1,
characterised in that
the quality of the transmission is monitored, preferably by comparing the data stream upon sending and upon receipt.

16. The method according to claim 1,
characterized in that
an error occurring during transmission is detected and, in order to prevent the error, information regarding the error is communicated to the sending device, the modification device, the forwarding device and/or a device for automating the transmission.

17. A computer program product which can be directly loaded onto the internal memory of a digital computer and comprises software portions, and by means of which the method steps according to claim 1, can be carried out when the computer program product is running on a computer.

18. The computer program product according to claim 17,
characterized in that
the computer program product is a computer program stored on a data carrier, preferably RAM, ROM, CD or similar, or on an appliance, or is a signal sequence representing data, which sequence is suitable for sending via a network of data-processing devices, in particular the Internet.

19. A network of data-processing devices, comprising means for carrying out the method according to claim 1.

20. The network according to claim 19,
characterized by
a pilot computer for creating a portal, a device for automating a transmission of a data stream and/or a device for sending the data stream and preferably, in each case individually or in any desired combination, additionally a device for receiving and distributing the data stream, a device for modifying the data stream, a device for forwarding the data stream and/or a device for using the data stream.
